(19) United States
(12) Patent Application Publication
(10) Pub. No.: US 2019/0291183 A1
(43) Pub. Date: Sep. 26, 2019

(54) METHOD FOR MANUFACTURING METALLIC COMPONENTS BY MEANS OF GENERATIVE PRODUCTION

(71) Applicant: MESSER GROUP GMBH, Bad Soden (DE)

(72) Inventors: Bernd HILDEBRANDT, Tönisvorst (DE); Dirk KAMPFFMEYER, Linnich (DE)

(73) Assignee: MESSER GROUP GMBH, Bad Soden (DE)

(21) Appl. No.: 16/302,269

(22) PCT Filed: Mar. 22, 2017
(86) PCT No.: PCT/EP2017/056841

§ 371 Date: Nov. 16, 2018

(30) Foreign Application Priority Data
May 24, 2016 (DE) 10 2016 006 383.1

(51) Int. Cl. B22F 3/105; B22F 3/10; B22F 3/24; B33Y 10/00; B33Y 40/00

(52) U.S. Cl. CPC B22F 3/1055; B22F 3/1007; B22F 3/24; B22F 2003/1056; B33Y 40/00; B22F 2003/248; B33Y 10/00

(57) ABSTRACT

In a method for manufacturing metallic components by means of generative production, a layer of metal powder is selectively melted or sintered by being exposed to an energy beam in an evacuated radiation chamber. When the radiation chamber is subsequently flooded with a cooling gas, the melted or sintered part solidifies to form a solid contour. Instead of the previously common practice of using helium, which is expensive and not readily available, as the cooling gas, it is proposed according to the invention to use a gas that contains hydrogen. Hydrogen has a higher thermal conductivity than helium and does not impair the surface of the workpiece, or only to a negligible extent.

The invention relates to a process for producing metallic components by means of generative manufacture, in which a metal powder layer is produced in an evacuated irradiation chamber and is selectively melted or sintered by action of an energy beam and the irradiation chamber is subsequently flooded with a cooling gas, with the melted or sintered parts derived from the metal powder solidifying to give a solid workpiece contour.

In present-day production, there is an increasing trend for generative manufacturing processes (also referred to as “additive manufacturing processes”). This term refers here to manufacturing processes in general in which a three-dimensional workpiece is produced layer-by-layer from a material composed of metal or polymer. While use thereof has hitherto been restricted predominantly to the manufacture of prototypes, there is now seen to be a great potential for use in mass production, in particular for relatively small runs and/or for producing complex three-dimensional components which are in use, for example, in aerospace engineering, the automobile industry or in medical technology.

In powder-based generative manufacturing processes, a pulverulent material is applied in a thin layer to a working surface. The material is melted or sintered with point accuracy according to a computer-aided model by means of an energy beam, in particular a laser beam or an electron beam. After resolidification, the melted or sintered material forms a solid contour (here also referred to as “workpiece contour”) which is joined to contours which have been previously and/or subsequently produced in the same way to give a workpiece. In this way, shaped bodies which, in particular, have a somewhat highly complex three-dimensional structure can be built up. Powder-based generative manufacturing processes are, for example, electron beam melting (EBM), selective laser melting (SLM) or selective laser sintering (SLS).

To protect the workpiece against adverse influences of the surrounding atmosphere, powder-based generative manufacturing processes usually take place under protective gas or under reduced pressure. After manufacture is complete, the workpiece or the workpiece contour has to cool down before further treatment. If a protective gas is used, this can assist the process of cooling; in the case of additive manufacturing processes which are carried out under reduced pressure, the workpiece contour produced has to be cooled and the previously evacuated irradiation chamber has to be flooded with a gas to ambient pressure. Here, it is possible, in particular, to flood the radiation chamber with an inert gas which simultaneously serves to cool the workpiece or the workpiece contour. Owing to its good thermal conduction properties, helium is at present predominantly used for this purpose.

EP 3 006 139 A1 proposes a process for the layer-by-layer production of a metallic workpiece by additive manufacturing, in which layers of a pulverulent metallic material are successively provided and irradiated with a laser beam, with a process gas being introduced in each case. The process gas serves to influence the chemical or physical properties of the molten metal of each layer in a targeted manner; accordingly, different layers are exposed to process gases of differing composition. For example, various argon- and helium-containing process gases are used here, with a varying proportion of helium resulting in different cooling rates, microstructural changes and material distortions of the workpiece contours produced. A process gas which contains not only an inert gas but also hydrogen in an amount of from 0.01% by volume to 50% by volume protects the metal melt during the laser beam treatment by binding of oxygen present in the metal powder. However, blanketing of the workpiece contours produced by a cooling gas is not provided for this subject matter. In addition, experience in connection with such process gases cannot readily be applied to manufacturing processes which proceed under reduced pressure.

WO 2015/155745 A1 describes a process for producing a workpiece by means of additive manufacturing, in which a layer of a pulverulent starting material is provided in an evacuated irradiation chamber. This layer is preheated and subjected to a selective melting process by exposure to an energy beam under reduced pressure, giving a workpiece contour which has to solidify due to cooling. In order to accelerate the cooling process, the irradiation chamber is flooded with an inert cooling gas stream. Helium or argon, for example, is used as cooling gases.

The use of helium or argon as cooling gas has hitherto been considered to be necessary because of the inert properties of the noble gases. Helium has a quite high thermal conductivity, which allows rapid cooling, but is very expensive and not always available on the market. Argon is cheaper but has a far lower thermal conductivity, as a result of which the use of argon instead of helium either leads to a slower cooling process or else requires a considerable increase in the cooling gas flow needed. In practice, the use of pure helium or a gas mixture which consists at least predominantly of helium as cooling gas has therefore become established, but this is associated with the abovementioned disadvantages.

It is an object of the invention to provide a process for producing metallic components by means of generative manufacture under reduced pressure, which compared to processes according to the prior art is cheaper at the same quality and is associated with a higher processing speed.

The object of the invention is achieved by a process having the features of claim 1. Advantageous embodiments of the invention are claimed in the dependent claims.

Thus, in a process for generative manufacture, in particular in an electron or laser beam melting process, in which a metallic workpiece is made up of workpiece contours which are made successively layer-by-layer in an evacuated irradiation chamber and are cooled by flooding of the irradiation chamber subsequent to manufacture with a cooling gas, a hydrogen-containing gas or gas mixture is, according to the invention, used as cooling gas.

The invention thus relates to additive manufacturing processes which are carried out in an irradiation chamber under reduced pressure and in which the irradiation chamber is, after manufacture of each workpiece contour, flooded with a cooling gas which simultaneously serves for cooling the workpiece contours.

It has surprisingly been found that hydrogen present in the cooling gas has no adverse effect or only a negligible adverse effect on the surface of the workpiece contour produced. In addition, the thermal conductivity of hydrogen exceeds that of helium, so that a hydrogen-containing cooling gas leads to accelerated cooling of the workpiece contour compared to the use of pure helium. For the present purposes, a “hydrogen-containing cooling gas” is a gas or gas mixture which consists entirely of hydrogen (H₂) or else comprises amounts of other gases in addition to hydrogen, in particular amounts of inert gases such as helium (He), argon (Ar) and/or nitrogen (N₂). Flooding of the irradiation chamber with the cooling gas is preferably carried out to ambient pressure (1 bar) after conclusion of the manufacture of the workpiece contours. At this point in time, the molten material of the workpiece contour has obviously already solidified at least on its surface to such an extent that the hydrogen-containing cooling gas no longer has any appreciable influence on the metallurgical properties of the workpiece. After the workpiece contour has been cooled to a prescribed target temperature, a new metal powder layer is provided and the irradiation chamber is again evacuated for producing the next contour.

The cooling gas preferably contains helium, argon and/or nitrogen in addition to hydrogen. The gas here can be a two-, three- or four-component mixture in which one or more of the gases helium, argon or nitrogen are present in addition to hydrogen. Particular preference is given to a mixture of hydrogen and helium and also to a mixture containing argon and/or nitrogen in addition to hydrogen and helium, with the proportions of argon and/or nitrogen in the mixture preferably not exceeding those of the lesser component among He or H₂.

A preferred cooling gas composition is a gas mixture having a proportion of hydrogen of from 97% by volume to 100% by volume. The balance consists of helium and/or argon and/or nitrogen, in particular of helium with amounts of argon and/or nitrogen. Here, two-component mixtures according to the invention (hydrogen and helium, hydrogen and argon, hydrogen and nitrogen) are also conceivable, as are three-component mixtures (hydrogen and helium with amounts of argon or nitrogen) or four-component mixtures (hydrogen, helium, argon and nitrogen). A preferred cooling gas contains, for example, from 97% by volume to 99.5% by volume of H₂, from 0.5% by volume to 3% by volume of He, a balance Ar and/or N₂. Owing to the high thermal conductivity of hydrogen, the high hydrogen content leads to particularly efficient cooling.

A predominant content of hydrogen in the cooling gas improves the efficiency of cooling because of the high thermal conductivity of hydrogen. However, particularly in cases in which there is some probability that the cooling gas will come into contact with ambient air, a cooling gas composition which consists predominantly, namely to an extent of from 70% by volume to 99.5% by volume, of helium, argon, nitrogen or a mixture of two or three of these gases and has a comparatively low hydrogen content of from 0.5% by volume to 30% by volume is advantageous. Any balance consists of argon and/or nitrogen. Firstly, the comparatively small proportion of hydrogen also significantly increases the thermal conductivity of the cooling gas, and secondly the hydrogen concentration going above the explosive limit of hydrogen on mixing of the cooling gas with ambient air is avoided.

The cooling gas according to the invention is preferably used after a beam melting process which is carried out under reduced pressure and in which a laser beam or an electron beam is used as energy beam. In particular, the beam melting process is selective electron beam melting (EBM), selective laser melting (SLM) or selective laser sintering (SLS).

The advantages of the process of the invention lie, in particular, in shortening of secondary process times in generative manufacture as a result of rapid removal of the process heat from the workpiece contour produced in each case, with at the same time the risk of oxidation of the workpiece by oxygen from the surroundings being countered reliably. In addition, hydrogen is significantly cheaper and more reliably available than the helium which has been predominantly used hitherto.

1. A process for producing metallic components by means of generative manufacture, in which a metal powder layer is produced in an evacuated irradiation chamber and is selectively melted or sintered by action of an energy beam and the irradiation chamber is subsequently flooded with a cooling gas, with the melted or sintered parts derived from the metal powder solidifying to give a solid workpiece contour, wherein a hydrogen-containing gas or gas mixture is used as cooling gas.

2. The process as claimed in claim 1, wherein the cooling gas is a gas mixture containing helium, argon and/or nitrogen in addition to hydrogen.

3. The process as claimed in claim 1, wherein the cooling gas contains a proportion of hydrogen of from 0.5% by volume to 30% by volume, balance helium and/or argon and/or nitrogen.

4. The process as claimed in claim 1, wherein the cooling gas contains a proportion of hydrogen of from 97% by volume to 100% by volume, balance helium and/or argon and/or nitrogen.

5. The process as claimed in claim 1, wherein a laser beam or an electron beam is used as energy beam.
